(19) United States
(12) Patent Application Publication
(10) Pub. No.: US 2019/0016594 A1
(43) Pub. Date: Jan. 17, 2019

(54) A REFORMER FOR PRODUCING SYNGAS

(71) Applicant: EAJV TECHNOLOGY INC., Richmond Hill (CA)

(72) Inventors: Paul SINGH, Montreal, Quebec (CA); Ali ALIZADEH, Richmond Hill, Ontario (CA)

(21) Appl. No.: 15/324,751

(22) PCT Filed: Apr. 5, 2016
(86) PCT No.: PCT/CA2016/050391

§ 371 Date: Jan. 9, 2017

(51) Int. Cl. C01B 3/38

(52) U.S. Cl. CPC C01B 3/382; C01B 2203/0238; C01B 2203/0261; C01B 2203/062; C01B 2203/127; C01B 2203/1023; C01B 2203/1058; C01B 2203/1094; C01B 2203/0877

(57) ABSTRACT

A reformer for producing syngas from a feed gas; the reformer contains a syngas reaction container having a partial oxidation (PDX) feed gas inlet, a dry reforming (DRM) feed gas inlet, and an outlet permitting a syngas to exit the syngas reaction container. The syngas reaction container has a PDX reaction zone and a DRM reaction zone. The DRM reaction zone is positioned downstream from the PDX reaction zone. The DRM reaction zone has a DRM reactor for performing a DRM reaction. One or more heat exchangers are provided in the syngas reaction container for controlling the temperature of the feed gases and/or reactions; wherein heat from the PDX reaction is used to heat the DRM reactor zone for performing the DRM reaction. Also, disclosed is a process for producing syngas from a feed gas and a system for performing a Fischer Tropsch reaction.

### TECHNICAL FIELD

The present invention relates to refining processes and in particular a reformer and a process for producing hydrocarbons from natural gas.

### BACKGROUND

Gas to liquids (GTL) is a refinery process intended to convert natural gas or other gaseous hydrocarbons into longer-chain hydrocarbons. The feed for this process can be natural, associated petroleum gas, or flare gas. The methane content of these sources can vary from about 30 to about 95 volume percent. Other constituents of natural gas can include ethane, propane, butanes, pentane (and heavier hydrocarbons), hydrogen sulfide, carbon dioxide, helium and nitrogen.

The GTL process typically consists of several steps. In a typical first step the heavy hydrocarbons are removed from compressed feed gas which is then treated to remove sulfur compounds such as H₂S, COS, CS₂ etc. Next the treated gas is converted to syngas (i.e. a mixture of H₂ and CO) at either high or low pressures.

There are four primary methods for syngas production from natural gas, namely: Steam Reforming (SMR), Partial Oxidation (PDX), Auto-thermal Reforming (ATR) and Dry Reforming (DRM).

In the SMR process methane is reacted with steam over a nickel based catalyst to produce syngas, at operation temperatures around 900° C. and H₂/CO ratio of >3. This type of reforming process is considered ideal for obtaining high-purity gaseous hydrogen. The steam reforming of methane is an endothermic process and, therefore, requires high energy, which makes this process very costly.

In the PDX process, methane is either catalytically or non-catalytically reformed with oxygen to produce syngas. The H₂/CO ratio of the produced syngas is lower than that of SMR. Hence, PDX does not need a hydrogen separation unit. The resulting syngas is suitable for further Fisher Tropsch processing. The partial oxidation of methane is an exothermic process and thus can be considered more economical than SMR or DRM.

The ATR process is a combination of PDX and SMR with methane being partially oxidized in the presence of oxygen and steam. The H₂/CO ratio for ATR is around 2.5.

The DRM process is based on reforming methane with carbon dioxide in the presence of a catalyst, to obtain syngas at a H₂/CO ratio of 1. This reforming process is very cost-intensive due to its endothermic nature requiring great amounts of energy. However, this method results in syngas having a lower H₂/CO ratio (i.e. 1). Synthesis gas with lower H₂/CO ratio increases the selectivity of long chain hydrocarbons in Fischer Tropsch reaction.

The reactions during PDX, SMR and DRM are:

CH₄+1/2O₂→CO+2H₂

CH₄+H₂O→CO+3H₂

CH₄+CO₂→2CO+2H₂

In a GTL process, the next step is processing of the syngas through a Fischer-Tropsch (FT) reactor, where syngas is converted to liquid hydrocarbon products and water, in the presence of a catalyst. The overall FT reactions include:

Production of alkanes: nCO+(2n+1)H₂→CₙH₍₂ₙ₊₂₎+nH₂O

Production of alkenes: nCO+2nH₂→CₙH₂ₙ+nH₂O

The water gas shift: CO+H₂O→CO₂+H₂

The FT reactor product is a mixture of water, hydrocarbons, by-products such as alcohols.

Conventional GTL technologies have disadvantages, including low yields (i.e. CO conversions of about 50%) and low carbon efficiency. Carbon efficiency equals the amount of carbon in product multiplied by 100 and divided per total carbon present in reactants. Unreacted CO, H₂, CO₂ and CH₄ can exhaust the FT reactor. Most of these gases in conventional process are converted to hydrogen and carbon dioxide through water gas shift reaction. The produced CO₂ is separated and purged to atmosphere which increases the carbon footprint or greenhouse gas emission.

In US 2015/0126628, the tail gas from the FT reactor (which contains CO, H₂, CO₂, CH₄, C₂H₆ and C₃H₈) is burned, produce CO₂ and flared into the atmosphere. The system requires large amount of sprayed water for cooling down the gas stream from the PDX reformer to the FT reactor to decrease the gas temperature in the FT reaction. All of the produced steam remains in the FT synthesis section, thus increasing the water content in the FT reactor which accelerates the water gas shift reaction which in turn leads to the conversion of more CO to CO₂ and consequently decreasing the production of C₅⁺. Additionally, the water is condensed which requires a lot of energy. The large amounts of water necessitate increase sized reactors, separators, piping, and all of the associated equipment.

In U.S. Pat. No. 7,879,919, the process converts all un-reacted CO in the FT tail gas to a water gas shift reactor to produce CO₂ and H₂. The produced CO₂ is separated and purged in to the atmosphere. Purging of CO₂ reduces the carbon efficiency of overall system as well as increasing the green house gas (GHG) emission.

In U.S. Pat. No. 4,822,521, the process combines the partial oxidation and steam reforming to perform auto-thermal reforming in order to adjust the H₂/CO ratio.

Accordingly, there is a need for a reformer and a process that more efficiently produces hydrocarbons from natural gas.

### SUMMARY OF THE INVENTION

In one aspect, the specification relates to a reformer, a system and a method for producing syngas from a methane-containing feed, wherein a combination of partial oxidation (PDX) and dry reforming (DRM) reactions are used. In a particular embodiment, the heat generated in the exothermic PDX reaction is transferred to the DRM reaction. In another embodiment, the heat produced from the exothermic PDX reaction is transferred to the endothermic DRM reaction through a heat exchanger. In another particular embodiment, the PDX reaction and DRM reaction are performed in a single reformer.

According to another aspect, the specification relates to a reformer having at least one zone for performing a PDX reaction and at least another zone for performing a DRM reaction, wherein heat produced from the exothermic PDX reaction is used for the endothermic DRM reaction.

In a particular aspect, the specification relates to a reformer, containing

a syngas reaction container having a partial oxidation (PDX) feed gas inlet for receiving a PDX feed gas, a dry reforming (DRM) feed gas inlet for receiving a DRM feed gas, and an outlet permitting a syngas to exit the syngas reaction container;

a PDX reaction zone in the syngas reaction container for performing a PDX reaction on the PDX feed gas to form a portion of the syngas;

a DRM reaction zone in the syngas reaction container, the DRM reaction zone being downstream from the PDX reaction zone, the DRM reaction zone having a DRM reactor for performing a DRM reaction on the DRM feed gas to form another portion of the syngas, the DRM reactor being in fluid communication with the DRM feed gas from the DRM feed gas inlet; and

one or more heat exchangers in the syngas reaction container for controlling the temperature of the feed gases and/or reactions;

wherein heat from the PDX reaction is used to heat the DRM reactor zone for performing the DRM reaction.

In another aspect, the specification relates to a process for producing syngas, the process comprising a reformer having a syngas reaction container, a DRM reactor and one or more heat exchangers, the DRM reactor and one or more heat exchangers positioned within the syngas reaction container, the process comprising the step of:

performing a PDX reaction on a PDX feed gas in a PDX reaction zone in the syngas reaction container to form a portion of the syngas; and

performing a DRM reaction on a DRM feed gas in a in a DRM reactor positioned in a DRM reaction zone in the syngas reaction container, the DRM reaction zone being downstream from the PDX reaction zone, for forming another portion of the syngas; and

wherein heat from the PDX reaction is used to heat the DRM reactor zone for performing the DRM reaction.

In an embodiment, the syngas produced from the process is used in a Fischer Tropsch (FT) reactor to form hydrocarbons and a FT tail gas. In a further embodiment, the FT tail gas is separated and re-treated to form the DRM feed gas for use in the process.

In another aspect, the specification relates to a system for performing a Fischer Tropsch (FT) reaction, the system containing a reformer in fluid communication with a Fischer Tropsch reactor, wherein the reformer is as disclosed herein.

### BRIEF DESCRIPTION OF THE DRAWINGS

FIG. 1 is a schematic of a reformer according to an embodiment disclosed herein;

FIG. 2 is a process flow diagram for a process for producing hydrocarbons from natural gas; and

FIG. 3 is a schematic of a reformer according to another embodiment of the present invention.

### DETAILED DESCRIPTION

Reference will be made below in detail to exemplary embodiments, examples of which are illustrated in the accompanying drawings. Wherever possible, the same reference numerals used throughout the drawings refer to the same or like parts.

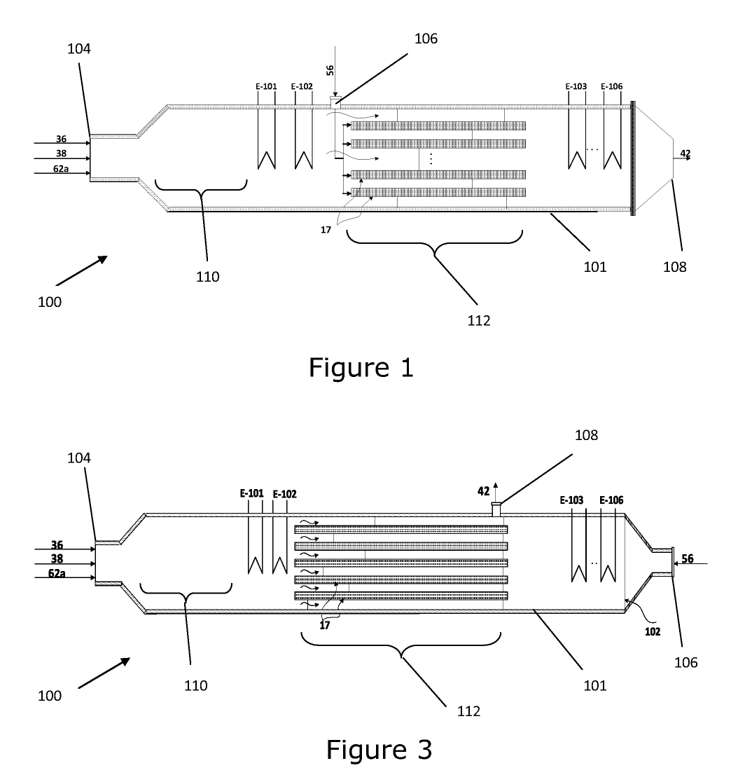

FIG. 1 shows a schematic view of a reformer (100) in accordance with an embodiment of this specification. The reformer (100) can be customized and applicable as the source of syngas formation in any GTL process, and can lead to several improvements based on changes it makes possible in the process.

The reformer (100) can be made of a syngas reaction container (101) having a partial oxidation (PDX) feed gas inlet (104) for receiving a PDX feed gas (36, 38 and 62a), a dry reforming (DRM) feed gas inlet (106) for receiving a DRM feed gas (56). Also, provided is an outlet (108) that allows a syngas formed in the syngas reaction container (101) to exit from the syngas reaction container (101), which can, in one embodiment, for example and without limitation, be directed towards a Fischer Tropsch (FT) reactor (18).

The shape, structure, orientation and material of construction of the reformer (100) disclosed herein is not particularly limited and can vary depending upon the design and application requirements. In one embodiment, for example and without limitation, the reformer (100) can be cylindrical having a constant diameter of 0.7 m to 3 m, or without or with one expansion in the DRM section.

In another embodiment, the reformer (100) can be installed either horizontally or vertically. In a particular embodiment, where production capacity is in the range of 50-1000 barrel per day (BPD) and for larger capacity, the reformer (100) can be installed vertically. According to a further embodiment, for horizontal installation the tubes (disclosed herein below) are expanding in both way but for vertical installation the tube can be supported at the bottom and vertical expansion are upward. According to another further embodiment, at least one support is used for each horizontal tube but for vertical tubes both support and suspension are used.

The position of the PDX feed gas inlet (104), DRM feed gas inlet (106) and outlet (108) is also not particularly limited, so long as the reformer (100) can perform the function of the reformer (100), particularly, utilization of the heat generated in the PDX reaction for assisting with the DRM reaction, as disclosed herein. In one embodiment, as disclosed in FIG. 1, the reformer (100) is cylindrical in shape, with the PDX feed gas inlet (104) one end and the outlet (108) at an opposing end of the reformer (100). In such an embodiment, the DRM feed gas inlet (106) can be positioned in between the PDX inlet (104) and outlet (108). Such an embodiment is referred to as a co-current reformer (100, FIG. 1), where the flow of PDX feed gas and the DRM feed gas is in the same direction. In another embodiment, as shown in FIG. 3, and referred to as a counter-current reformer (100) (due to opposing flow of the PDX and DRM feed gases), the PDX feed gas inlet (104) and DRM feed gas inlet (106) are positioned at opposing ends of a cylindrical reformer (100), while the outlet (108) is positioned in between the PDX feed gas inlet (104) and DRM feed gas inlet (106).

The syngas reaction container (101) as disclosed herein can be provided with a PDX reaction zone (110) for performing a PDX reaction on the PDX feed gas (36, 38 and 62a) to form a portion of the syngas. The process for carrying out a PDX reaction is not particularly limited and should be known to a person of skill in the art. As disclosed herein above, the PDX reaction involves reaction of methane (CH₄) with oxygen (O₂) to form carbon monoxide (CO) and hydrogen (H₂).

The syngas reaction container (101) is also provided with a DRM reaction zone (112) in the syngas reaction container (112). The DRM reaction zone being downstream from the PDX reaction zone. The term ‘downstream’ should be understood by a person of skill in the art. In the current instance, downstream relates to occurring after the PDX reaction zone (110). The DRM reaction zone (112) having a DRM reactor for performing a DRM reaction on the DRM feed gas (56) to form another portion of the syngas. In one embodiment, for example and without limitation, as shown in FIGS. 1 and 3, the DRM reactor is formed by a plurality of DRM tubes (17), where the DRM reaction takes place. The DRM tubes (17) are coupled to the DRM feed gas inlet (106), using for example and without limitation, tubes, so that the DRM feed gas remains separated from and avoid mixing with gases in the PDX reaction zone (110). This allows the DRM reactor (tubes (17) to be in fluid communication with the DRM feed gas from the DRM feed gas inlet (106).

The shape, structure, position and dimensions of the DRM reactor is not particularly limited and can be varied depending upon design and application requirements. In one embodiment, for example and without limitation, as shown in FIGS. 1 and 3, the DRM reactor is formed by a plurality of DRM tubes (17). According to another embodiment, the DRM tubes (17) are 1-6 inches in diameter. According to another further embodiment, the DRM tubes (17) are between 2-4 inches in diameter. According to another embodiment of the present invention the DRM tubes of the reformer of the present invention are installed after the PDX flame and the exchangers (E101 and E102). According to an embodiment, the DRM catalyst is located inside the DRM tubes (17) and the recycled gas streams from the FT reactor (stream 56) are co- (FIG. 1) or counter-currently (FIG. 3) introduced into the DRM tubes.

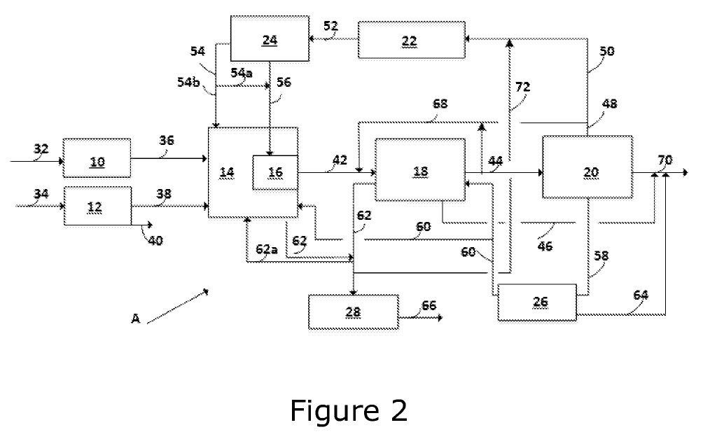

Based on the design of the reformer (100), the hot syngas from the PDX reaction zone (110) of the reformer (section 14 FIG. 2), enters the DRM reaction zone (112). In one embodiment, for example and without limitation, the DRM tubes (17) can be surrounded by the hot syngas from the PDX reaction. This can provide the heat for carrying out the endothermic DRM reaction in the DRM tubes (17).

The DRM feed gas (56) entering the DRM tubes (17) from one end can then undergo the DRM reaction in the DRM tubes (17) to form another portion of the syngas, produced from the DRM reaction, and exit out from an opposing end of the DRM tubes. According to an embodiment, the DRM feed gas (56) is a recycled gas (as further described herein). In another embodiment, the DRM feed gas (56, or recycled gas) is compressed up to, for example and without limitation, at least 1 bar over that of the syngas from PDX to prevent it from flowing back to the DRM tubes before being introduced into the DRM tubes. According to an embodiment, the syngas produced in the PDX and DRM section are mixed together and before leaving the reformer (100) as stream (42).

In accordance with an embodiment disclosed in the specification, the reformer (100) is provided with one or more heat exchangers in the syngas reaction container for controlling the temperature of the feed gases and/or reactions. According to one embodiment, the reformer (100) to be used in the process, includes a plurality of internal heat exchangers (e.g. E101 to E106) to help increase the heat efficiency of the overall process and allow for controlling the temperature along the reformer. According to a further embodiment, U-shaped or spiral or radiant tubes are applicable as the heat exchangers. According to a further embodiment, U-tube heat exchangers are installed inside the reformer to prevent tube's expansion. Also spiral with the extended surface can be used and the reformer can be internally insulated to minimize its heat loss, leading to the formation of a decreasing temperature gradient from the partial oxidation zone to the dry reforming zone.

In one embodiment, for example and without limitation, as shown in FIG. 1, heat exchangers E-101 and E-102 are provided between the PDX reaction zone (110) and the DRM reaction zone (112) for controlling the temperature of the gases (including syngas produced from the PDX reaction). In a particular embodiment, the heat exchanger E-101 and E-102 can help to reduce the temperatures of gases flowing from the PDX reaction zone (110) before entry into the DRM reaction zone (112).

In a further embodiment, for example and without limitation, as shown in FIG. 1, additional heat exchangers (E-103 to E-106) can be provided to control the temperature of the syngas produced in the reformer (100) before exiting and use in the Fischer Tropsch reactor (18). In a particular embodiment, as shown, heat exchangers (E-103 to E-106) help to reduce the temperature of the syngas for use in the FT reaction.

The reformer (100) disclosed herein can help to increase the efficiency and decrease the carbon footprint of the GTL processes through the application of a novel combined reformer, which allows for recycling CO₂ from FT purge gas. In addition, it can help to reduce the amount of the vented, purged or combusted gas, through separating and recycling purge gas into the reformer and FT reactor. Moreover, it can help to increase the carbon and energy efficiency of the GTL process and can help improve the yield of hydrocarbon liquid product in the overall process through recycling the FT purge gas, in a way that the water shift reaction is not increased hydrogen production in the tail gas.

Some of the above advantages can be achieved through the design of a mixed reformer (100), as disclosed herein, for performing at least the partial oxidation (PDX) and dry reforming (DRM) stages in one vessel which decreases the oxygen consumption of overall GTL plant.

In addition, the reformer (100) can help in eliminating the CO₂ removal package from FT purge gas and avoiding purging CO₂ into the atmosphere to decrease the green house gas emissions. Further, the reformer (100) can help to increase the load of FT reactor through adding the recycle gas through the pre-reformer, the membrane system and internal DRM tubes (as disclosed herein) in the reformer to increases the total liquid production of GTL units.

In one embodiment, some of the advantages noted above can be achieved through installing a plurality of heat exchangers inside at least one section of the reforming vessel to increase the heat efficiency, which allows for controlling the temperature gradient along the reformer, thus increasing the heat efficiency of the overall process. This in part allows for the adjustment of the internal temperature of all or a section of the reformer for recycling CO₂ in to the syngas reaction container for catalytic DRM, which increases the overall carbon efficiency of the process and decreases the carbon footprint. The above, along with the combination of partial oxidation and dry reforming sections in an either co-current or counter-current reformer can help to attain some of the advantages noted above.

In one embodiment, some of the advantages attained using the reformer disclosed herein can be achieved through recycling the produced CO₂ and unreacted syngas and produced methane from the FT reactor into a pre-reformer, separation system and dry reforming reactor.

In an embodiment of the reformer disclosed herein, partial oxidation and dry reforming reactions are performed as independent from one another (i.e. the syngas from the partial oxidation section(s) of the reforming vessel is not introduced in to the DRM section(s) thereof), but the output syngas from the reformer can be fed to GTL reactor independently or as a mixture.

In a further embodiment of the reformer disclosed herein, controlling the temperature of the reforming vessel through installing at least one DRM tube inside the reformer can help to increase the total heat efficiency and through producing steam inside the heat exchanger tubes to produce power in the steam turbine. In a further embodiment, advantages of the reformer can be achieved through designing the reforming vessel in a way that the heat produced in the sections by the highly exothermic PDX reaction, is used as the heat source for sections of the vessel dedicated to the endothermic DRM reaction. In addition, additional advantages can be achieved through the application of one or a plurality of the reformers, disclosed herein, in parallel or series or a combination of both in a correspondingly modified FT process function.

The reformer disclosed herein can be used in a process, in which the stream containing hydrocarbons, mostly methane, is initially introduced into the PDX section after preheating in one of the internal heat exchangers inside the reformer and being stripped off its sulfur compounds. The produced syngas is next fed to the Fischer-Tropsch (FT) reactor where it is subjected to the FT reactions after dropping its temperature by passing the gas through internal heat exchangers and the surrounding internal DRM tubes. The tail gas of the FT reactor is then divided into at least two portions, one of which is directly recycled into the FT reactor, while a second portion is fed into a three phase separator, where its water and hydrocarbon contents are separated. One portion of this second stream (purge gas) is next recycled into the FT reactor. Another portion of this gas is introduced into a pre-reforming system and/or a separation system to produce a mixture of CO₂, CH₄, H₂, CO and H₂O, and is then is introduced into the DRM reaction zone of the reformer, with or without mixing with methane and/or steam, depending on its composition, where it is subjected to a DRM reaction, and the resulting synthesis gas is finally re-fed into the FT reactor after or without mixing with the syngas from the PDX reaction zone of the reformer.

An embodiment of a typical process utilizing the reformer, disclosed herein, is described below and illustrated in FIG. 2.

According to this process at least one 30,000 Nm³/day up to 9,000,000 Nm³/day stream of a methane containing gas from, for example and without limitation, flare, associated, natural gas or bio gas (32) is introduced into the process through stage 10. In stage 10, the gas is introduced into the process through a metering station after removal of its H₂S content in a removal vessel and being compressed in a gas compressor. The compressed gas is then passed through a chiller to separate its heavier hydrocarbons (C₃⁺) and to remove the organic sulfur compounds. It is next preheated to 350-450° C. using heat, for example and without limitation, from one of the heat exchangers in the reformer (E101-106), and then introduced into the hydrodesulphurization catalytic bed. The treated gas (36) eventually is fed into the section 14 of the reformer.

At least one air stream (34) is introduced in to a pressure swing adsorption (PSA), an Air Separation Unit (ASU) or a membrane system (stage 12). The air stream is separated into at least one enriched oxygen stream of 40-95% pure oxygen (38) and at 16,000 Nm³/day up to 5,500,000 Nm³/day and a side stream of enriched nitrogen (40). The enriched oxygen (38) is compressed up to the operation pressure and heated to 350-450° C., using heat, for example and without limitation, through one of the exchangers (E 101-106) to be ready for introduction into the PDX section (14) of an R1 or R2 type reformer (FIGS. 1 and 3). The enriched nitrogen stream (40) can be purged or used for other application like instrumentation.

Next, at least one, for example and without limitation, 1.5 ton/day up to 800 ton/day stream of steam (62a) is provided individually or from at least one of the heat exchangers inside the reformer and FT reactor (section 18, Process A) and is introduced into the inlet of section 14 of the reformer under the operation pressures of, for example and without limitation, 15-40 bars and preferably 20-35 bars.

The treated gas (36) is also introduced into the reformer, where in the PDX part (section 14) of the reformer it undergo the highly exothermic partial oxidation reaction, as a result of which the temperature of the mixture is increased up to about 1000-1400′C. The residence time of the gas in this part of the reactor is, for example and without limitation, between 0.2-20 sec.

Next the reacted gas mixture passes through exchanger tubes (E 101 and E 102), during which stage, its temperature drops to about 800-1000′C, based on the number, dimensions and arrangement of the heat exchangers in this region. The number, dimensions and arrangement of the heat exchangers, are arranged in a way that the temperature of the gas preferably reaches 850-950° C. and then gas enters the part of reformer where the DRM tubes are installed and is passed inside and preferably surrounding the part 16 (DRM) of the reformer.

Given that DRM is a highly endothermic reaction requiring operating temperatures of 700-900° C., to attain high equilibrium conversion of CH₄ and CO₂ to H₂ and CO and minimize the thermodynamic driving force for carbon deposition, the hot syngas surrounding the DRM tubes (section 16) within the reformer serves as a source of heat, providing all or a portion of the required energy for the DRM reaction.

The DRM tubes (17 FIG. 1), are filled with a catalyst that can be chosen from any of the conventional catalysts used for the conventional DRM process including Ni based catalyst promoted with Fe, Rh, Ru, Pt, and Pd metals and supported on γ-Al₂O₃ or MgO-γ-Al₂O₃, or Mg Al₂O₄ or honeycomb or carbon nanotubes, or any other proper catalyst suitable for the DRM reaction.

Based on the design of the reformer, the operating conditions and the desired outcome the streams in the DRM tubes (16) and that in the PDX section of the reformer (14) can be chosen to be co (R1 figurel) or counter-current (R2 FIG. 3).

The output product of the DRM tubes has a temperature of around 650-850° C., and preferably around 750-800° C. This temperature is reduced along the reformer as the heat exchangers (E-103-E106) that are in contact with the PDX and DRM product stream and the temperature of the output stream (42) which leaves the reforming vessel can be between 300-500° C.

Next the produced syngas stream from the reformer passes through a cooler or water scrubber and is introduced into the FT section at 200-350° C. (18). The reactor design, feed properties, and operating conditions are designed in a way that the H₂/CO ratio of the syngas stream from reformer (14+16) fall between, for example and without limitation, 1.65-2.2, preferably 1.7-2.1 and most preferably between 1.8-2 before entering the FT reactor (18).

The FT reactor (18) can be one or a plurality of slurry bed, fluidized bed and fixed bed reactors. Based on the embodiments, in the case of production rates of 100-1500 BPD with inputs in the range of 30,000-360,000 Nm³/day fixed bed reactor can be preferred, while for higher feed and production scales the application of both slurry bed and fixed bed reactors can be more viable. In case more than one FT reactor is used the reactors can be in series or parallel with each other.

In general, for producing 100 to 500 BPD of the final product one FT reactor can be adequate, while for higher production rates of up to 25000 BPD a single reactor or at least two parallel reactors can be used.

The operation temperature of the FT reactor can be between 180-280° C., and preferably between 210-260° C. for low temperature Fischer-Tropsch and 320-370° C. and preferably between 330-360° C., for high temperature operations.

The feed syngas (42) can next be introduced into the tube side of the FT reactor at GHSV of around 500-6000 h⁻¹, and preferably at between 1000-3000 h⁻¹. Given the fact that the FT reaction is highly exothermic, the temperature can be controlled by passing the process water (60) inside the shell side of the FT reactor and hence the steam is produced (62), which is sent to the steam header to pass to the steam turbine (28).

The catalyst in the FT reactor can be chosen from one or a combination of FT catalysts based on Co, Fe, Ni, Pd, Pt, Rh, Cd, supported on Alumina, Al₂O₃, TiO₂, SiO₂, MgO, honeycomb, Carbon nanotubes or any combination thereof with metal/supports weight percent of 5-50%.

FT crude (46) leaves from the bottom of FT reactor. The gas product (44) form FT section (18), can be sent to the separation unit (20) after cooling down to 30-60° C. where it is separated to water (58), C₅⁺ (70) and tail gas (48).

As to the tail gas (48), 20-80 vol. %, preferably 30-50 vol. % of this stream (68) can be recycled into the FT reactor (18) in order to control the temperature at around 210-260° C. and increases the C₅⁺ production in FT reactor.

The water (58) can be sent to a distillation tower and treatment section (26) to completely separate its hydrocarbon content (64) and then can be stored for use as the process water (60). The process water can be fed to the FT reactor (18) to keep temperature constant or to the PDX section (14) of the reformer. In both cases steam is produced (62), and can be sent to the steam turbine (28). A portion of steam (62a) also can be fed into the reformer (FIG. 1). The electrical energy (66) produced in the steam turbine can be then used to drive auxiliary equipment like compressors and pumps. The low pressure steam from steam turbine can be further used as a heat source in the process and finally cooled down in the cooling tower and condensed to be used as the process water (not shown in process flow diagram).

The rest of the tail gas (50) can be passed through a pre-reformer (22) after preheating up to, for example and without limitation, 250-400° C. and preferably 300-400° C. and mixing with, for example and without limitation, 0-40 wt. %, and preferably 10-30 wt. % of steam (72). The output gas from the pre-reformer (22) can be, for example and without limitation, 500-750° C., preferably 600-700° C. and most preferably 620-680° C.

The output gas stream (52) from the pre-reformer can be passed to the DRM section (16) of the R1 or R2 type reformer directly, or goes through the cooling system (not shown in process in FIG. 2) to be cooled down to 200-300° C. and then is introduced into at least one membrane module (24).

One output from the membrane module (56) containing, for example and without limitation, 40-100 mol. %, preferably 50-100 mol. %, and most preferably 60-100 mol. % of CO₂ can be introduced to the DRM section of the reformer after preheating up to 300-400° C. Another output of the membrane module (54), which contains, for example and without limitation, 40-100 mol. %, preferably 50-100 mol. %, and most preferably 60-100% of CH₄ is divided into two portions (54a and 54b). In one embodiment, 0-40 vol. %, preferably 0-20 vol. % and most preferably 0-10 vol. % of stream 54 (54a) can be mixed with stream 56 and fed into the DRM part (16) of reformer R1 or R2. In another embodiment, for example and without limitation, 60-100 vol. %, preferably 80-100 vol. % and most preferably 90-100 vol. % of stream 54 (54b) is fed directly fed into the PDX section (14) of reformer R1 or R2.

The specification discloses exemplary embodiments for purposes of illustration, and which are not in any way intended to be limiting to the claimed invention.

### EXAMPLES

For these examples, Calriant FTMax catalyst from Sud-Chemie was used in a fixed bed reactor. The FT catalyst was reduced according to the recommended reduction and startup procedures. Partial oxidation and fixed bed FT reactions were carried out at 1200-1300° C. and 220° C., respectively. The operation pressure for both reforming and FT reactions was around 25 bar·GHSV for FT reactor was 1700-1800 h⁻¹.

The system was fed using around 26 Nm³/h gas stream comprising 95 mol % CH₄, 3 mol % C₂H₆, 1 mol % C₃H₈ and 1 mol % H₂ and around 16 Nm³/h oxygen with 95% purity. Specific minor amount of steam also was fed to the PDX zone.

The FT reactor tubes were around 10 m in length and 1.25 inch in diameter. The FT catalyst was loaded inside the FT reactor with inert material at the top and bottom. Four tests were carried out under the conditions detailed below and the results are summarized in table 1.

Test No. 1:

The feed gas was introduced first to the PDX reactor, then to the fixed bed FT tubular reactor after cool down to 220° C. The FT reactor's temperature was controlled with circulating water and steam in a close loop at 220° C. Tests were performed for 48 hours. The FT crude was sent to a three phase separator to separate water and C₅⁺. Around 85 vol. % of tail gas was recycled to FT reactor and the rest was sent to the flare.

Test No. 2:

As in Test No. 1, feed gas was introduced to the reformer. FT tail gas was then fed to the pre-reformer after heating till 250° C. 5.3 kg/h high pressure steam was added to the pre-reformer. The product from the pre-reformer was then introduced into the PDX section and all of the gas then passed inside the DRM tube with 2 inch diameter and 6 m length at 650-700° C. Ni—Co/Al—Mg—O catalyst was used for DRM reaction. The theoretical space velocity for DRM reactor was 1800-2000 Nm³/hr/m³. The produced syngas was introduced into the FT reactor. This test was performed for 72 hours.

Test No. 3:

As in Test Nos. 1 and 2, the feed gas was introduced to the reformer. FT tail gas passed to the pre-reformer after heating till 250° C. Around 6 kg/h high pressure steam was added to the pre-reformer. The product from the pre-reformer was introduced into the DRM tube with 2 inch diameter and 6 m length. The produced syngas from the PDX reaction was passed surrounding the DRM tube. The produced syngas from the reformer (includes syngas produced from the partial oxidation and dry reforming reactions) was introduced into the FT reactor. This test was performed for 72 hours.

Test No. 4:

For this case the output gas from pre-reformer was cooled down till 200° C. and was introduced into the membrane module. Around 50 mol % of methane was separated and introduced into the PDX zone of the reformer, the rest of gas is introduced into DRM tube and finally the produced syngas from both parts is subjected to the FT reactor.

TABLE 1

| | H₂/CO ratio | C₅⁺ |
|---|---|---|
| Test No. | (after reformer) | (barrel/day) |
| 1 | 1.9-1.95 | 1.83 |
| 2 | 1.9-1.95 | 2.35 |
| 3 | 1.85-1.9 | 2.44 |
| 4 | 1.85-1.9 | 2.55 |

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

| Numeral | Item |
|---|---|
| 100 | Reformer |
| 101 | Syngas reaction container |
| 104 | POX feed gas inlet |
| 106 | DRM feed gas inlet |
| 108 | Outlet |
| 110 | POX reaction zone |
| 112 | DRM reaction zone |
| (10) | H₂S removal and gas compress unit |
| (12) | Air separation section |
| (14) | Partial oxidation section |
| (16) | Dry reforming section |
| (17) | Dry reforming tubes |
| (18) | Fischer Tropsch section |
| (20) | FT product Separation section |
| (22) | Recycle gas pre-reforming section |
| (24) | Membrane module section |
| (32) | Natural gas, biogas, flare gas or associated gas stream |
| (34) | Air stream |
| (36) | Treated and compressed gas stream |
| (38) | Enriched oxygen stream |
| (40) | Nitrogen enriched stream |
| (42) | Syngas stream |
| (44) | Fischer Tropsch gas product stream |
| (46) | Fischer Tropsch crude product stream |
| (48, 50) | Fischer Tropsch Tail gas stream |
| (52) | Pre-reformed gas stream |
| (54, 54a, 54b) | Methane enriched gas stream |
| (56) | Carbon dioxide enriched gas stream |
| (58) | Fischer tropsch water product stream |
| (60) | Process water stream |
| (62, 62a, 72) | Steam stream |
| (66) | Energy stream |
| 70 | C₅⁺ stream |

What is claimed is:

1. A reformer, comprising:
a syngas reaction container having a partial oxidation (PDX) feed gas inlet for receiving a PDX feed gas, a dry reforming (DRM) feed gas inlet for receiving a DRM feed gas, and an outlet permitting a syngas to exit the syngas reaction container;
a PDX reaction zone in the syngas reaction container for performing a PDX reaction on the PDX feed gas to form a portion of the syngas;
a DRM reaction zone in the syngas reaction container, the DRM reaction zone being downstream from the PDX reaction zone, the DRM reaction zone having a DRM reactor for performing a DRM reaction on the DRM feed gas to form another portion of the syngas, the DRM reactor being in fluid communication with the DRM feed gas from the DRM feed gas inlet; and
one or more heat exchangers in the syngas reaction container for controlling the temperature of the feed gases and/or reactions;
wherein heat from the PDX reaction is used to heat the DRM reactor zone for performing the DRM reaction.

2. The reformer according to claim 1, wherein the PDX reaction zone is positioned proximate the PDX feed gas inlet and the DRM reaction zone is positioned proximate the outlet.

3. The reformer according to claim 1, wherein a first heat exchanger is positioned proximate to the DRM feed gas inlet, the heat exchanger controlling temperature of the gases entering the DRM reaction zone.

4. The reformer according to claim 1, wherein a first heat exchanger is positioned intermediate the PDX reaction zone and the DRM reaction zone, the heat exchanger controlling temperature of the gases entering the DRM reaction zone.

5. The reformer according to claim 1, further comprising a second heat exchanger positioned proximate to the outlet for the syngas, the second heat exchanger controlling temperature of the syngas exiting the syngas reaction container.

6. The reformer according to claim 1, wherein each of the one or more heat exchangers is a U-shaped, spiral, or radiant tube type of heat exchanger.

7. The reformer according to claim 1, wherein the DRM reactor is formed by a plurality of DRM tubes.

8. The reformer according to claim 7, wherein the DRM tubes are between 2 to 4 inch in diameter and 4-12 meters in length.

9. The reformer according to claim 1, wherein the DRM reactor comprises a Ni-based catalyst promoted with Fe, Rh, Ru, Pt, and Pd metals and supported on γ-Al₂O₃, MgO-γ-Al₂O₃, Mg Al₂O₄, honeycomb or carbon nanotubes.

10. A process for producing syngas, the process comprising a reformer having a syngas reaction container, a DRM reactor and one or more heat exchangers, the DRM reactor and one or more heat exchangers positioned within the syngas reaction container, the process comprising the steps of:
performing a PDX reaction on a PDX feed gas in a PDX reaction zone in the syngas reaction container to form a portion of the syngas; and
performing a DRM reaction on a DRM feed gas in a in a DRM reactor positioned in a DRM reaction zone in the syngas reaction container, the DRM reaction zone being downstream from the PDX reaction zone, for forming another portion of the syngas; and
wherein heat from the PDX reaction is used to heat the DRM reactor zone for performing the DRM reaction.

11. The process according to claim 10, wherein the PDX reaction zone is positioned proximate the PDX feed gas inlet and the DRM reaction zone is positioned proximate the outlet.

12. The process according to claim 10, further comprising:
controlling temperature of the portion of the syngas formed from the PDX reaction before entering the DRM reaction zone using a first heat exchanger.

13. The process according to claim 10, further comprising:
controlling temperature of the syngas exiting the syngas reaction container using a second heat exchanger.

14. The process according to claim 10, wherein the DRM reactor comprises a Ni-based catalyst promoted with Fe, Rh, Ru, Pt, and Pd metals and supported on γ-Al₂O₃, MgO-γ-Al₂O₃, Mg Al₂O₄, honeycomb or carbon nanotubes.

15. A system for performing a Fischer Tropsch (FT) reaction, the system comprising:
a reformer in fluid communication with a Fischer Tropsch reactor, the reformer comprising:
a syngas reaction container having a partial oxidation (PDX) feed gas inlet for receiving a PDX feed gas, a dry reforming (DRM) feed gas inlet for receiving a DRM feed gas, and an outlet permitting a syngas to exit the syngas reaction container for entry into the Fischer Tropsch reactor;
a PDX reaction zone in the syngas reaction container for performing a PDX reaction on the PDX feed gas to form a portion of the syngas;
a DRM reaction zone in the syngas reaction container, the DRM reaction zone being downstream from the PDX reaction zone, the DRM reaction zone having a DRM reactor for performing a DRM reaction on the DRM feed gas to form another portion of the syngas, the DRM reactor being in fluid communication with the DRM feed gas from the DRM feed gas inlet; and
one or more heat exchangers in the syngas reaction container for controlling the temperature of the feed gases and/or reactions;
wherein heat from the PDX reaction is used to heat the DRM reactor zone for performing the DRM reaction.

16. The system according to claim 15, wherein the reformer is as defined in claim 2.

17. The system according to claim 15, further comprising:
introducing a PDX feed gas containing methane and oxygen into the syngas reaction, reacting the PDX feed gas in the PDX reaction zone to form carbon monoxide (CO) and hydrogen (H₂);
permitting flow of CO and H₂ from the syngas reaction container to the Fischer Tropsch reactor;
performing a Fischer Tropsch reaction to convert at least a portion of the CO and H₂ into hydrocarbons and a Fischer Tropsch tail gas in the Fischer Tropsch reactor;
separating and diverting a first portion of the Fischer Tropsch tail gas from the hydrocarbons produced;
treating the Fischer Tropsch tail gas to produce the DRM feed gas; and
introducing the DRM feed gas to the DRM reaction zone for carrying out the DRM reaction.

18. The system according to claim 17, further comprising: recycling a second portion of the Fischer Tropsch tail gas back to the Fischer Tropsch reactor.

19. The system according to claim 17, further comprising a pre-reforming or separation system to produce the DRM feed gas.

20. The system according to claim 15, wherein the DRM feed gas comprises a mixture of carbon dioxide (CO₂), methane (CH₄), carbon monoxide (CO), hydrogen (H₂) and water (H₂O).

21. The system according to claim 15, wherein the Fischer Tropsch reactor comprises at least one or a combination of fixed or slurry bed reactors.

22. The system according to claim 21, wherein a fixed bed reactor is used for 50 to 1500 BPD units.

23. The system according to claim 21, wherein both the fixed bed and the slurry bed reactors are used for production rates higher than 1500 BPD.

24. The system according to claim 15, wherein the catalyst in the Fischer Tropsch reactor is one or a combination of the FT catalysts based on Co, Fe, Ni, Pd, Pt, Rh, Cd, supported on Alumina, Al₂O₃, TiO₂, SiO₂, MgO, honeycomb, carbon nanotubes or any combination thereof with metal/supports weight percent of 5-50%.
